(19) United States
(12) Patent Application Publication
(10) Pub. No.: US 2002/0134680 A1
(43) Pub. Date: Sep. 26, 2002

(54) Apparatus and method for electrophoresis

(76) Inventors: Shmuel Cabilly, Gedera (IL); Ilana Margalit, Ramat Gan (IL); Uri Yogev, Yavne (IL); Tim Updyke, Temecula, CA (US)

Correspondence Address: Eitan, Pearl, Latzer & Cohen-Zedek, Suite 210, One Crystal Park, 2011 Crystal Drive, Arlington, VA, 22202-3709, US

(21) Appl. No.: 10/091,430

(22) Filed: Mar. 7, 2002

Related U.S. Application Data
(60) Provisional application No. 60/273,956, filed on Mar. 8, 2001.

(51) Int. Cl. G01N 27/26; G01N 27/447

(52) U.S. Cl. 204/468; 204/456; 204/466; 204/606; 204/616

(57) ABSTRACT

An apparatus and method for conducting electrophoresis, includes a cassette, gel, and electrolyte solution in contact with the gel. The electrolyte solution has high capacity and low conductivity properties, so that low volumes of electrolyte solution can be used.

### RELATED APPLICATIONS

This application claims priority of provisional application serial No. 60/273,956, filed on Mar. 8, 2001, which is incorporated in its entirety by reference herein.

### FIELD OF THE INVENTION

The present invention relates generally to the field of electrophoresis and more particularly to an electrophoresis apparatus having a reservoir with a small volume of an electrolyte solution.

### BACKGROUND OF THE INVENTION

A great deal of diagnostic procedures and laboratory research are carried out wherein DNA, RNA or proteins are separated according to their physical and chemical properties via electrophoresis. This process is widely used and has many applications For example, it is used to analyze DNA molecules according to their resultant size after being digested by restriction enzymes. It is also used to analyze the products of a polymerase chain reaction (PCR).

Typically, electrophoresis is carried out in a separation matrix, such as a gel of agarose or polyacrylamide. The purpose of using a gel in many applications is to reduce mixing caused by convection currents in the electrolyte solution. Usually, agarose gels are cast in open trays and form a horizontal slab whereas polyacrylamide gels are vertically cast between two glass plates.

In order to effect the electrophoresis separation, two opposite ends of the gel are exposed to a buffered solution, which is connected by electrodes to an electrical power source. Once the electrical power source is switched on, the electric field forces negatively charged molecules to move towards the anode and positively charged molecules to move towards the cathode.

The electrodes that are commonly used for electrophoresis separation are generally made of inert metals such as platinum, palladium, carbon or stainless steel. These inert electrodes in aqueous solution induce water electrolysis, which produces hydroxyl ions at the cathode side and protons at the anode side. As a result, large volumes of buffer are used in order to maintain the pH.

Many different gel separation materials have been disclosed, with different compositions, pH characteristics, voltage requirements, etc. The goal of most of the recent innovations in the field has been to provide an electrophoresis gel which can be used to perform a faster, more accurate, more stable, or more versatile electrophoresis.

U.S. Pat. No. 5,464,516 to Takeda et al. discloses an electrophoresis gel layer using polyacrylamide, which remains stable even when stored for long periods of time, and is available for analyzing substances of a wide molecular weight range. The composition of the separation layer includes a solution with acid, amine and ampholyte. The particular concentrations as well as the choice of ampholyte based on pK and overall pH may be manipulated to suit the particular requirements of the system. By changing the parameters, such as the concentration of a particular ampholyte, the electrical potential gradient distribution in the gel can be controlled, thus controlling the types of substances which can be analyzed.

Similarly, U.S. Pat. No. 6,096,182 to Updyke et al. discloses an electrophoresis gel at a neutral pH. The advantage of producing such a gel is that the gel system is stable, with reduced reactivity and increased shelf life.

U.S. Pat. No. 5,464,517 to Hjerten et al. discloses an electrophoresis buffer which has a high buffering capacity and low electrical conductivity. The advantage of this type of buffer, particularly in capillary electrophoresis, is that it allows the separation to be performed at a higher voltage and consequently more quickly.

In addition, to maintain pH constant during electrophoresis large volumes of buffer are used. The use of large buffers makes the electrophoresis apparatus cumbersome, inconvenient to use and non-disposable. For example, U.S. Pat. No. 4,874,491 discloses a solid buffer gel with a high concentration of buffer, where the solid pieces are separate from the running gel.

### SUMMARY OF THE INVENTION

There is provided, in accordance with one embodiment of the present invention, apparatus for conducting electrophoresis therein. The apparatus includes a substantially closed electrophoresis chamber, an electrophoresis gel located within the electrophoresis chamber, and electrolyte solution in contact with the gel, wherein the electrolyte solution has high buffer capacity and low conductivity properties.

There is also provided, in accordance with another embodiment of the present invention, apparatus for conducting electrophoresis therein. The apparatus includes an electrophoresis chamber, an electrophoresis gel within the chamber having a running zone and at least one ion reservoir zone. Electrolyte solution in contact with the gel has high buffer capacity and low conductivity properties. The volume of the ion reservoir zone is less than twice the volume of the running zone of the gel.

There is provided, in accordance with a further embodiment of the present invention, apparatus for conducting electrophoresis. The apparatus includes a separating gel, an anode and a cathode at two ends of the gel, and electrolyte solution in contact with the gel. The anode is made of an electrochemically ionizable metal, and the electrolyte solution is of a composition such that migration of ions generated by the anode is inhibited.

There is provided, in accordance with another embodiment of the present invention, apparatus for conducting electrophoresis. The apparatus includes a substantially closed electrophoresis chamber, and electrophoresis gel within the chamber, an anode and cathode at two ends of the gel, and electrolyte solution in contact with the gel on at least one of the two ends. The gel includes a running zone and an ion reservoir zone, wherein the volume of the ion reservoir zone is less than twice the volume of the running zone. The anode is made of electrochemically ionizable metal, and the electrolyte solution is of a composition such that migration of ions generated by the anode is inhibited. The electrolyte solution has high capacity low conductivity properties.

There is provided, in accordance with another embodiment of the present invention, a system for conducting electrophoresis. The system includes an electrical power source, a cassette for conducting electrophoresis, and a support for supporting the cassette. The cassette has conductive elements therein, an electrophoresis gel, and electrolyte solution having high capacity and low conductivity properties in contact with the gel. The support also connects the electrical power source to the conductive elements of the cassette.

There is provided, in accordance with another embodiment of the present invention, a method for conducting electrophoresis in a closed cassette The method includes the steps of: introducing at least one test sample into a body of gel, applying an electrical field to the body of gel, and driving an electrophoresis by providing ions for maintaining an electric field required for electrophoresis by electrolyte solution having high capacity and low conductivity properties.

There is also provided, in accordance with another embodiment of the present invention, a method for reducing the volume of buffer used in electrophoresis. The method includes the steps of providing a high capacity low conductivity electrolyte solution, incorporating the electrolyte solution in an electrophoresis gel at a specified pH, and applying a voltage to the electrophoresis gel, thereby eliciting chemical reactions so as to equilibrate the specified pH.

There is also provided, in accordance with another embodiment of the present invention, a method for inhibiting migration of an ion through an electrophoresis gel. The method includes the steps of: providing an anode in an electrophoresis gel, providing electrolyte solution within the electrophoresis gel and in contact with the anode, applying a voltage to the electrophoresis gel so as to generate an electrochemical reaction releasing ions from the anode, and inhibiting migration of the released ions by a chemical reaction between the released ions and the electrolyte solution.

### BRIEF DESCRIPTION OF THE DRAWINGS

FIG. 1 is an illustration of an electrophoresis cassette, according to one embodiment of the present invention; and

FIG. 2 is a cross section illustration of the cassette of FIG. 1.

### DETAILED DESCRIPTION OF THE PRESENT INVENTION

As an alternative, or in addition to, ion exchange matrices, the present invention discloses an electrolyte solution of low volume, capable of being used in an open apparatus for gel electrophoresis or in a closed cassette. The electrolyte solution has specific characteristics, namely high capacity and low conductivity, which make it ideal for use in closed cassette systems. The use of the term “substantially closed” indicates that the cassette includes a lid with openings.

The term “electrolyte solution” in the current context refers to a solution for maintaining pH, and optionally a reservoir of additional ions or molecules included therein. The additional ions may be, for example, ions used to enhance the resultant bands of the electrophoresis. Alternatively, the additional ions may be ions used for staining the separated substances.

In conventional electrophoresis systems, a large reservoir of buffer is used between the electrodes and the separating gel. In this case, a relatively low concentration of electrolytes may be present, since with such a high volume, the total number of ions is high. Without the use of high number of ions, changes in conductivity and pH would occur during the separation process. These changes would occur because of depletion of ions due to electrophoretic migration, and by formation of H⁺, OH⁻produced through electrolysis of water.

The use of electrolyte solution containing a high concentration of ions in the running gel is impractical because it would drastically slow down separation allowing diffusion of the analytes thereby affecting their resolution.

A solution to this problem would be the use of an electrolyte system providing high buffer capacity and low conductivity. This type of electrolyte system is characterized by its ability to resist large changes in solution composition while keeping low current values. The high capacity and low conductivity is achieved by using pH conditions where a substantial amount of the molecules are in a non-charged form.

The use of this type of electrolyte solution, particularly but not limited to agarose gel electrophoresis systems, eliminates the need for large reservoir tanks and allows for a small volume of electrolyte solution to be used.

The electrolyte solution of the present invention may enable performance of electrophoresis at a voltage of 1-50 V/cm, with conductivity of 30×10⁻⁵-140×10⁻⁵ ohm⁻¹/cm at relatively high electrolyte concentrations, while keeping the pH in the running gel constant throughout the electrophoresis period. Electrolyte concentration may vary from 50-300 mM. In a preferred embodiment, the electrolyte concentration is 175 mM. In another embodiment, the electrolyte concentration is 100 mM.

In a preferred embodiment of the present invention, a combination of amine molecules and “Zwitter ions” (ZI), also known as ampholytes, are used. These elements are combined in solution at a pH value that is higher than the pK of the amine and lower than the higher pK value of the ZI. Under these conditions the concentration of charged amine molecules and the concentration of net negatively charged ZI is low, as shown in the examples hereinbelow.

Another embodiment of the present invention includes electrolyte solution comprising a weak acid and a ZI in conditions such that the pH of the solution is higher than that of the ZI and lower than the acid pK. An example of this system would be a buffer at pH 4.0, composed of acetate (which has a pK of 4.72 at 25 degrees), and beta alanine (which has a pK of 3.59).

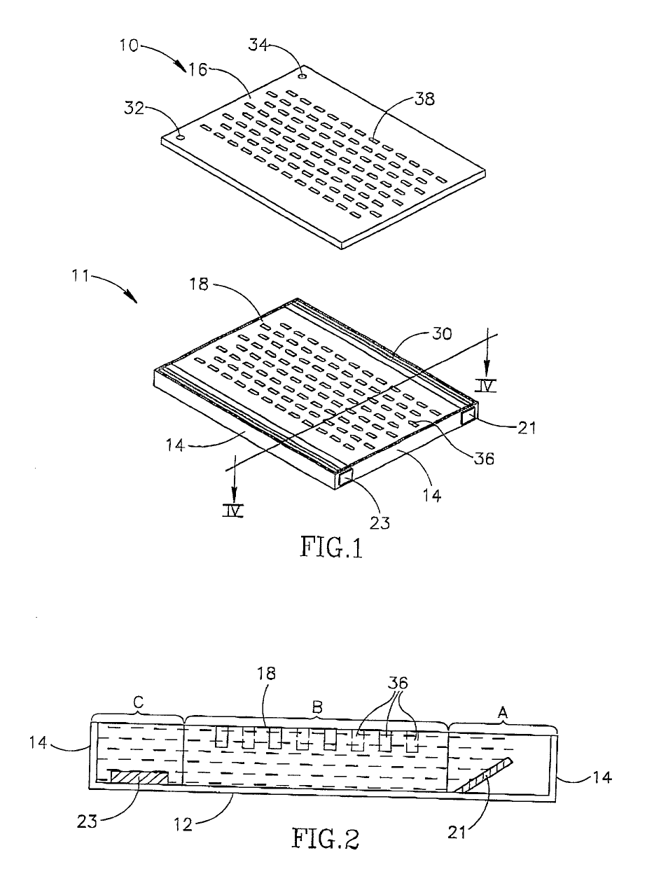

Reference is now made to FIG. 1, which shows one embodiment of the present invention, including a substantially closed cassette. Cassette 10 comprises a three dimensional running area 11 having bottom wall and side walls, referenced 12 and 14 respectively, and a top wall 16 having a specified thickness. Cassette 10 is substantially closed in that it is enclosed by walls 12, 14 and 16, but it also comprises vent holes and apertures as will be described hereinbelow. In one embodiment, the thickness ranges from 0.1-10 mm. In another embodiment, the thickness is 1.5 mm. Cassette 10 as shown in FIG. 1 has a specified length, width and height. In one embodiment, the length ranges from 100-200 mm, the width ranges from 50-150 mm and the height ranges from 1-10 mm. In a preferred embodiment, length, width and height are 100 millimeters (mm), 80 mm and 6.7 mm, respectively. In another preferred embodiment, length, width and height are 108 mm, 135 mm and 6.7 mm, respectively.

Bottom wall 12 and top wall 16 are preferably made of any suitable UV transparent material, such as the TPX plastic commercially available from MITSUI of Japan or the Polymethylmethacrylate (PMMA) plastic commercially available from Repsol Polivar S.P.A. of Rome, Italy. Cassette 10 may include vent holes 32 and 34 to allow for gaseous molecules that might be generated due to the electrochemical reaction (e.g., oxygen and/or hydrogen) to be released. In one embodiment, vent holes range in diameter from 0.5-2 mm. In a preferred embodiment, vent holes are 1 mm in diameter.

As seen in the cross section illustration (IV-IV) of FIG. 2, area 11 comprises a gel matrix 18 which may be any suitable gel matrix for electrophoresis, such as an agarose gel or a gel made of polyacrylamide (available from, for example, Sigma, St. Louis, Mont., USA). A plurality of wells 36 may be introduced into gel 18, by using a “comb” having a row of protruding teeth positioned so that the teeth project into the gel layer while it sets. In one embodiment, the plurality of wells ranges from 1-200 wells In another embodiment, the plurality of wells ranges from 8-12 wells. In another embodiment, the plurality of wells includes 96-104 wells.

When the gel has set, the comb is removed to leave a row of wells 36, or holes, in the layer. In one embodiment, wells 36 are dimensions of 0.5-5 mm wide, 1-5 mm long, and 3-5 mm deep, and are used to introduce samples of the molecules to undergo molecular separation. One row or several rows may be formed.

Area 11 also comprises two conductive electrodes referenced 21 and 23 which, when connected to an external direct current (DC) electrical power source, provide the electric field required to drive electrophoresis. In the illustrated embodiment, electrode 21 is the cathode and electrode 23 is the anode. The system may also include a support for connecting conductive elements of cassette 10 to the power source. In one embodiment, the support configured to connect to one or more gels simultaneously. Further, the system optionally includes a camera for documentation, and a light source for visualization. In one embodiment, the light source is of variable wavelengths. In another embodiment, the light source is a UV light source. A colorimetric dye capable of interacting with molecules undergoing electrophoresis may be added so as to enable visualization while the molecules are in situ.

As shown in FIG. 2, cassette 10 is divided into three functional zones: A, B and C. Zone A is an ion reservoir, adjacent to cathode 21. In one embodiment, the volumes of Zones A and C are each less than twice the volume of Zone B. In another embodiment, the volume of at least Zone A or Zone C is less than twice the volume of Zone B. Zone B, which includes a running zone, is the area in which the molecule is separated and viewed. Zone C is the area between Zone B and anode 23, and is also an ion reservoir. In a preferred embodiment, Zone A has a volume of 4.5 ml, Zone B has a volume of 16.5 ml, and Zone C has a volume of 2.5 ml. In another preferred embodiment, Zone A has a volume of 2.5 ml, Zone B has a volume of 40 ml, and Zone C has a volume of 6 ml.

The ion reservoir may be in semi-solid form, in which the ion reservoir is incorporated within a porous substance such as a gel matrix. Thus, the “electrolyte solution” is present along the entire length of cassette 10, and includes both the running zone, Zone B, and the ion reservoir sources, Zones A and C.

In another embodiment, an open cassette is used. In this embodiment, the ion source reservoir may either be in semi-solid form or in liquid form.

It will be appreciated that any ratio of volumes of zones A or C to zone B that is smaller than conventional electrophoresis may be used. However, the use of high capacity/low conductivity electrolyte solution is particularly advantageous when the ratios of are small.

Cathode 21 and anode 23 may be any material normally used as an anode and cathode in electrophoresis, such as platinum or aluminum. In one embodiment of the present invention, anode 23 is made of electrochemically ionizable metal, such as copper. In another embodiment of the present invention, cathode 21 is made of aluminum, and anode 23 is made of copper In a preferred embodiment of the present invention, both cathode 21 and anode 23 are made of copper.

When an electrochemically ionizable metal is used as anode 23, upon the application of an electric field, protons are not generated by anode 23. Instead, the metal electrode is decomposed into ions which migrate toward cathode 21. An unexpected result of using some of the embodiments of the electrolyte solutions of the present invention in combination with ionizable metal, is that the migration of metal ions through the gel is inhibited, and thereby limited to zone C, as will be shown in the examples below.

When amine molecules and “Zwitter ions” (ZI) are used, the Z acts as the main buffering agent at zone A adjacent to cathode 21. However, the amine molecules play a role as well.

ZI Buffering

The zwitter ions are the main OH⁻scavengers. Most of the ZI molecules, when at their isoelectric point, are in the following form: ³¹a ZI b⁺. Thus, the following occurs:

⁻a ZI b⁺(high concentration)+OH⁻(from the cathode)→⁻a ZI bOH

The now negatively charged ions, ⁻a ZI bOH, migrate toward the anode.

The ZI also play a role as H⁺scavengers. However, in this embodiment of the present invention, the amine ions are the main H⁺scavengers.

⁻a ZI b⁺(high concentration)+H⁺(from the anode)→HaZI b⁺

The now positively charged ions, H aZI b⁺, migrate toward the cathode.

Finally, a negligible amount of the ZI are in the forms of Ha ZI b⁺and Ha ZI b.

Ha ZI b⁺+OH⁻→⁻a ZI b⁺+HOH

Ha ZI bOH+OH⁻→⁻a ZI bOH+HOH

⁻a ZI bOH+H⁺→a ZI b⁺+HOH

Ha ZI bOH+H⁺→Ha ZI b⁺+HOH

A particularly low conductivity is achieved when the pK of the amine is lower than that of the ZI by about 0.9-2 pH units. The solution pH is different by 0.5-1 pH units from the pK of its constituents; it is higher than the amine pK and lower than the pK of the ZI. Under these conditions, the amine and ZI are only fractionally charged and the result is that the solution is significantly less conductive than conventional systems.

Similarly, in the case of a weak acid and ZI, the ions are only fractionally charged when the pH of the system is lower than the pK of the weak acid by 0.5-1 pH units and higher than the pK of the ZI by 0.5-1 pH units. Since there a tradeoff between low conductivity and buffering capacity, it will be appreciated by persons skilled in the art that the differences should not be much greater than that.

Several combinations of amine and ZI were tested for use with a DNA sample (100 bp+1 kb ladder from Fermentas) containing a tracking dye, such as bromophenol blue. A gel of 1% agarose was run at 90-120V (currents=4-9 mAmps) until the bromophenol blue reached a distance of 5.7 cm from the wells. In these examples, an aluminum cathode and a copper anode were used. In addition, the electrolyte concentration was 100 mM, and the size of the cassette in length, width and thickness was 100 mm, 80 mm and 6.7 mm, respectively.

### EXAMPLE 1

For an electrolyte solution at pH=7, the following components were used:

Amine: 50 mM Bis-Tris

(bis[2-hydroxyethyl]iminotris[hydroxymethyl]methan)(pK=6.5)

ZI: 50 mM Tricine (N-tris[hydroxymethyl]methylglycine)(pK=8.1)

The pH of the gel was measured at the beginning and at the end of the run and it was found to be constant throughout the running time. In addition, migration of the copper ions in the gel was inhibited. This phenomenon, which is likely caused due to some formation of a salt complex, was found to occur in many, but not all, of the compositions of the gel electrolyte solution.

### EXAMPLE 2

For an electrolyte solution at pH=7, the following components were used:

Amine: 50 mM Bis-Tris (pK=6.5)

ZI: 50 mM Bicine (N,N-bis[2-hydroxyethyl]glycine)(pK=8.3)

The pH of the gel was found to be constant throughout the running time. The migration of the copper ions was inhibited.

### EXAMPLE 3

For an electrolyte solution at pH=7, the following components were used:

Amine: 50 mM Bis-Tris (pK=6.5)

ZI: 50 mM Glycilglycine (pK=8.2)

The pH of the gel was found to be constant throughout the running time. The migration of the copper ions was inhibited.

### EXAMPLE 4

For an electrolyte solution at pH=7, the following components were used:

Amine: 50 mM Bis-Tris (pK=6.5)

ZI: 50 mM TAPS

(N-tris[hydroxymethyl]methyl-3-aminopropanesulfonic acid (pK=8.4) The pH of the gel was found to be constant throughout the ruining time. In this case, the migration of the copper ions was not inhibited and the ions migrated through the running gel.

### EXAMPLE 5

For an electrolyte solution at pH=7, the following components were used:

Amine: 50 mM Bis-Tris (pK=6.5)

ZI: 50 mM EPPS ((N-[hydroxyethylpiperazine-N′[3-propanesulfonic acid)pK=8)

The pH of the gel was found to be constant throughout the running time. The migration of the copper ions was not inhibited and the ions migrated through the running gel.

### EXAMPLE 6

For an electrolyte solution at pH=9.0, the following components were used:

Amine: 50 mM Tris (pK=8.1)

ZI: 60 mM Glycine (pK=9.6)

The pH of the gel was found to be constant throughout the running time. The migration of the copper ions was inhibited.

### EXAMPLE 7

For an electrolyte solution at pH=10, the following components were used:

Amine: 50 mM Amino methyl propanol (pK=9.7)

ZI: 50 mM Proline (pK=10.6)

The pH of the gel was found to be constant throughout the running time. The migration of the copper ions was inhibited.

When using these types of compositions, in some instances the migration of copper ions toward the cathode was inhibited. Movement was limited to a distance of about 5 mm from the edge of the copper electrode, thereby not penetrating the running zone of the gel. This phenomenon was not shared by all of the tested buffers. When for example, TAPS and EPPS were used, the pH of the gel remained constant but the copper ions penetrated the running zone.

The Bis-Tris-Tricine buffer (Example 1) was tested also with cassettes where both electrodes are made of Aluminum. In this case the pH in the running zone was kept constant throughout the running time; however, the anode generated gaseous oxygen.

It will be appreciated that the embodiments described hereinabove are described by way of example only and that numerous modifications thereto, all of which fall within the scope of the present invention, exist. For example, gels may be either vertical or horizontal, and may be made of polyacrylamide, agarose, or any other gel used in the art. In addition, any other electrolyte solution that provides a high concentration of low conductivity ions should be included in the scope of the invention. In addition, separation of all types of molecules commonly separated by electrophoresis, such as DNA, RNA, carbohydrates, lipids, peptides and proteins, should be included in the scope of the invention.

It will be appreciated by persons skilled in the art that the present invention is not limited to what has been particularly shown and described hereinabove. Rather, the scope of the present invention is defined only by the claims that follow:

What is claimed is:

1. Apparatus for conducting electrophoresis therein, the apparatus comprising:
a substantially closed electrophoresis chamber;
an electrophoresis gel located within said electrophoresis chamber; and
electrolyte solution in contact with said gel,
wherein said electrolyte solution has high buffer capacity and low conductivity properties.

2. Apparatus as in claim 1, wherein said electrolyte solution and said electrophoresis gel have a similar concentration of ions.

3. Apparatus as in claim 1, wherein said electrolyte solution comprises an ion reservoir.

4. Apparatus as in claim 1, wherein said electrolyte solution comprises an amine and a zwitter ion.

5. Apparatus as in claim 4, wherein said amine is selected from the group consisting of Bis-Tris, tris and amino methyl propanol.

6. Apparatus as in claim 4, wherein said zwitter ion is selected from the group consisting of tricine, bicine, glycilglycine, TAPS, EPPS, glycine and proline.

7. Apparatus as in claim 4, wherein the pK of said amine is lower than that of said zwitter ion by 0.9-2 pH units.

8. Apparatus as in claim 1, wherein said electrolyte solution comprises a weak acid and a zwitter ion.

9. Apparatus as in claim 1, wherein said electrophoresis gel is agarose.

10. Apparatus as in claim 1, wherein said electrophoresis gel is polyacrylamide.

11. Apparatus as in claim 2 wherein said ion reservoir is in a semi-solid form.

12. Apparatus as in claim 1, further comprising an anode and a cathode.

13. Apparatus as in claim 12, wherein said anode is made of an electrochemically ionizable metal.

14. Apparatus as in claim 13, wherein said electrochemically ionizable metal copper.

15. Apparatus as in claim 13, wherein said electrochemically ionizable metal comprises metal ions, wherein the migration of said metal ions is inhibited by components of said electrolyte solution.

16. Apparatus as in claim 1, further comprising ion exchange matrices at at least one end of said electrophoresis gel.

17. Apparatus for conducting electrophoresis therein, the apparatus comprising:
an electrophoresis chamber;
an electrophoresis gel comprising a running zone and at least one ion reservoir zone, said gel located within said electrophoresis chamber; and
electrolyte solution in contact with said electrophoresis gel,
wherein said electrolyte solution has high capacity and low conductivity properties, and the volume of said at least one ion reservoir zone is less than twice the volume of said running zone of said electrophoresis gel.

18. Apparatus as in claim 17, wherein said electrolyte solution and said electrophoresis gel have a similar concentration of ions.

19. Apparatus as in claim 17, wherein said electrolyte solution comprises an amine and a zwitter ion.

20. Apparatus as in claim 19, wherein said amine is selected from the group consisting of Bis-Tris, tris and amino methyl propanol.

21. Apparatus as in claim 19, wherein said zwitter ion is selected from the group consisting of tricine, bicine, glycilglycine, TAPS, EPPS, glycine and proline.

22. Apparatus as in claim 19, wherein the pK of said amine is lower than that of said zwitter ion by 0.9-2 pH units.

23. Apparatus as in claim 17, wherein said electrolyte solution comprises a weak acid and a zwitter ion.

24. Apparatus as in claim 17, wherein said electrophoresis gel is agarose.

25. Apparatus as in claim 17, wherein said electrophoresis gel is polyacrylamide.

26. Apparatus as in claim 17 wherein said ion reservoir zone is in a semi-solid form.

27. Apparatus as in claim 17 wherein said ion reservoir zone is in liquid form.

28. Apparatus as in claim 17, further comprising an anode and a cathode.

29. Apparatus as in claim 28, wherein said anode is made of an ionizable metal.

30. Apparatus as in claim 29, wherein said electrochemically ionizable metal copper.

31. Apparatus as in claim 28, wherein said electrochemically ionizable metal comprises metal ions, wherein the migration of the metal ions is inhibited by components of said electrolyte solution.

32. Apparatus as in claim 17, further comprising an ion exchange matrix adjacent to said ion reservoir zone.

33. Apparatus for conducting electrophoresis, said apparatus comprising:
a running gel;
an anode and a cathode at two ends of said gel; and
electrolyte solution in contact with said gel,
wherein said anode is made of an electrochemically ionizable metal and wherein said electrolyte solution is of a composition such that migration of ions generated by said anode is inhibited.

34. Apparatus as in claim 33, wherein said migration of ions is limited to an area adjacent to said anode.

35. Apparatus as in claim 33, wherein said electrochemically ionizable metal copper.

36. Apparatus as in claim 33, wherein said electrochemically ionizable metal comprises metal ions, wherein the migration of said metal ions is inhibited by components of said electrolyte solution.

37. Apparatus as in claim 33, wherein said anode is comprised of copper, and said ions are copper ions.

38. Apparatus as in claim 33, wherein said electrolyte solution comprises an amine and a zwitter ion.

39. Apparatus as in claim 38, wherein said amine is selected from the group consisting of Bis-Tris, tris and amino methyl propanol.

40. Apparatus as in claim 38, wherein said zwitter ion is selected from the group consisting of tricine, bicine, glycilglycine, glycine and proline.

41. Apparatus as in claim 38, wherein the pK of said amine is lower than that of said zwitter ion by 0.9-2 pH units.

42. Apparatus as in claim 33, wherein said electrolyte solution comprises a weak acid and a zwitter ion.

43. Apparatus as in claim 33, wherein said running gel is agarose.

44. Apparatus as in claim 33, wherein said running gel is polyacrylamide.

45. Apparatus as in claim 33 wherein said electrolyte solution comprises an ion reservoir.

46. Apparatus as in claim 45 wherein said ion reservoir is in a semi-solid form.

47. Apparatus as in claim 45 wherein said ion reservoir is in liquid form.

48. Apparatus as in claim 33, further comprising ion exchange matrices at at least one end of said running gel, in contact with said anode and said cathode.

49. Apparatus for conducting electrophoresis, said apparatus comprising:
a substantially closed electrophoresis chamber;
an electrophoresis gel comprising a running zone and an ion reservoir zone, said electrophoresis gel located within said electrophoresis chamber; and
an anode and a cathode at two ends of said gel; and
electrolyte solution in contact with said electrophoresis gel at least on one of said two ends,
wherein said anode is made of an electrochemically ionizable metal, wherein said electrolyte solution is of a composition such that migration of ions generated by said anode is inhibited,
wherein said electrolyte solution has high capacity and low conductivity properties, and
wherein the volume of said ion reservoir zone is less than twice the volume of said running zone of said electrophoresis gel.

50. Apparatus as in claim 49, wherein said electrochemically ionizable metal copper.

51. Apparatus as in claim 49, wherein said electrolyte solution and said electrophoresis gel have a similar concentration of ions.

52. Apparatus as in claim 49, wherein said electrolyte solution comprises an amine and a Zwitter ion.

53. Apparatus as in claim 52, wherein said amine is selected from the group consisting of Bis-Tris, tris and amino methyl propanol.

54. Apparatus as in claim 52, wherein said Zwitter ion is selected from the group consisting of tricine, bicine, glycilglycine, glycine and proline.

55. Apparatus as in claim 52, wherein the pK of said amine is lower than that of said Zwitter ion by 0.9-2 pH units.

56. Apparatus as in claim 49, wherein said electrolyte solution comprises a weak acid and a Zwitter ion.

57. Apparatus as in claim 49, wherein said electrophoresis gel is agarose.

58. Apparatus as in claim 49, wherein said electrophoresis gel is polyacrylamide.

59. Apparatus as in claim 49 further comprising ion exchange matrices at at least one end of said electrophoresis gel.

60. Apparatus as in claim 49 wherein said ion reservoir zone is in a semi-solid form.

61. Apparatus as in claim 49 wherein said ion reservoir is in liquid form.

62. A system for conducting electrophoresis, the system comprising:
an electrical power source;
a cassette for conducting an electrophoresis therein and having conductive elements therein, said cassette comprising:
an electrophoresis gel; and
electrolyte solution in contact with said gel, wherein said electrolyte solution has high capacity and low conductivity properties; and
a support for supporting said cassette and for connecting said electrical power source to said conductive elements of said cassette.

63. A system according to claim 62 further comprising a light source, thereby enabling visualization of said electrophoresis while said cassette is in situ.

64. A system according to claim 62 wherein said light source is of variable wavelengths.

65. A system according to claim 62, wherein said light source is a UV light source, and said cassette comprises UV sensitive material capable of interacting with molecules undergoing electrophoresis and of emitting light.

66. A system according to claim 62 further comprising a calorimetric dye capable of interacting with molecules undergoing electrophoresis, thereby enabling to conduct said electrophoresis and to visualize it while said cassette is in situ.

67. A system according to claim 62 further comprising camera means for documenting the results of said electrophoresis.

68. A system according to claim 62 wherein said support is configured to connect to one or more gels simultaneously.

69. A method for conducting electrophoresis in a closed cassette, comprising the steps of:
introducing at least one test sample into a body of gel comprising a running zone;
applying an electrical field to said body of gel; and
driving an electrophoresis by providing ions for maintaining an electric field required for electrophoresis by electrolyte solution having high capacity and low conductivity properties, wherein said electrolyte solution comprises an ion reservoir zone with a volume less than twice than a volume of said running zone.

70. A method for reducing the volume of buffer used in electrophoresis, comprising the steps of:
providing an electrolyte solution of high buffer capacity and low conductivity;
incorporating said electrolyte solution in an electrophoresis gel at a specified pH; and
applying a voltage to said electrophoresis gel, thereby eliciting chemical reactions so as to equilibrate said specified pH.

71. A method for inhibiting migration of an ion through an electrophoresis gel, comprising the steps of:
providing an electrochemically ionizable anode in an electrophoresis gel;
providing an electrolyte solution within said electrophoresis gel and in contact with said anode;
applying a voltage to said electrophoresis gel so as to generate an electrochemical reaction releasing ions from said anode; and
inhibiting migration of said released ions by a chemical reaction between said released ions and components of said electrolyte solution.

72. A method as in claim 71 wherein said anode is comprised of copper and said ions are copper ions.
